(19) United States
(12) Patent Application Publication
(10) Pub. No.: US 2011/0198200 A1
(43) Pub. Date: Aug. 18, 2011

(54) CHILDPROOF LIGHT SWITCH GUARD

(76) Inventor: MIHALY ARPAD DRABIK, Nashville, MI (US)

(21) Appl. No.: 12/688,177

(22) Filed: Feb. 16, 2010

(51) Int. Cl. H01H 9/00

(52) U.S. Cl. 200/43.01; 174/67

(57) ABSTRACT

A method of restricting small children from accessing a standard household light switch. Existing light switch guard designs require extra steps to allow access to the light switch, such as using a key or pushing a button to lock and unlock the device, or unscrewing a screw to allow repositioning of the switch guard to lock the light switch in the on or off position. The childproof light switch guard restricts small children from accessing a standard household light switch while remaining fully functional to adults by nature of the anatomical differences between a child's hand and an adult's hand without pushing any buttons, moving any parts, locking and unlocking, or removal and repositioning.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Existing light switch guard designs require extra steps to allow access to the light switch such as using a key to lock and unlock the device, pushing an extra button to lock or unlock the device, or unscrewing a screw to allow repositioning of the switch guard to lock the light switch in the on or off position.

### BRIEF SUMMARY OF THE INVENTION

The childproof light switch guard is a protective guard that restricts small children from accessing a standard household light switch. When installed on a wall mounted light switch, the childproof light switch guard renders the light switch inoperable to small children while remaining fully functional to adults by nature of the anatomical differences between a child's hand and an adult's hand without pushing any buttons, moving any parts, locking and unlocking, or removal and repositioning.

### BRIEF DESCRIPTION OF THE SEVERAL VIEWS OF THE DRAWINGS

FIG. 1: Front view of childproof light switch guard.

FIG. 2: Side view of childproof light switch guard.

FIG. 3: Back view of childproof light switch guard.

FIG. 4: Top view of childproof light switch guard.

FIG. 5: Front view of mounted childproof light switch guard.

FIG. 6: Side view of mounted childproof light switch guard.

FIG. 7: An adult hand accessing a light switch with a childproof light switch guard.

FIG. 8: A child's hand attempting to access a light switch with a childproof light switch guard.

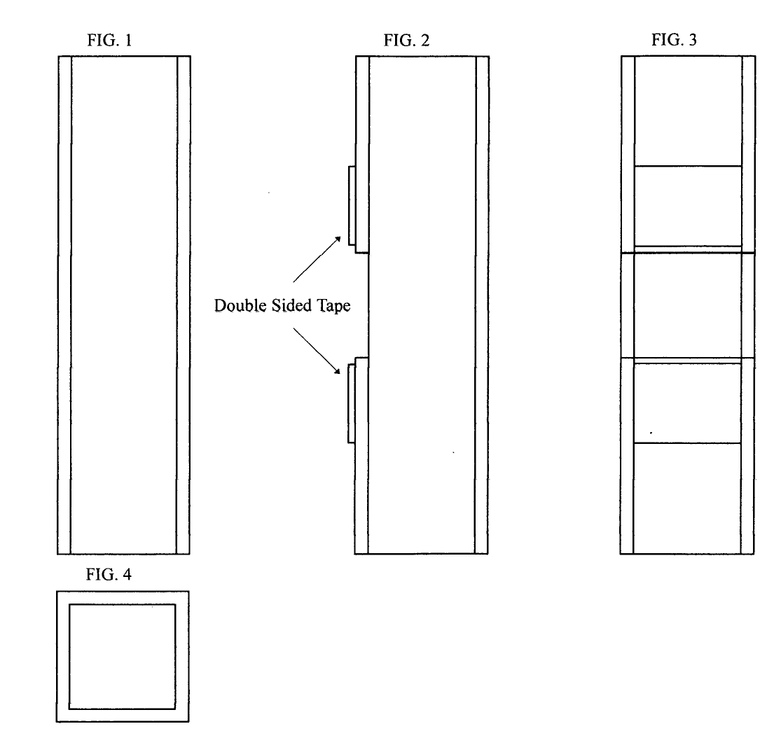

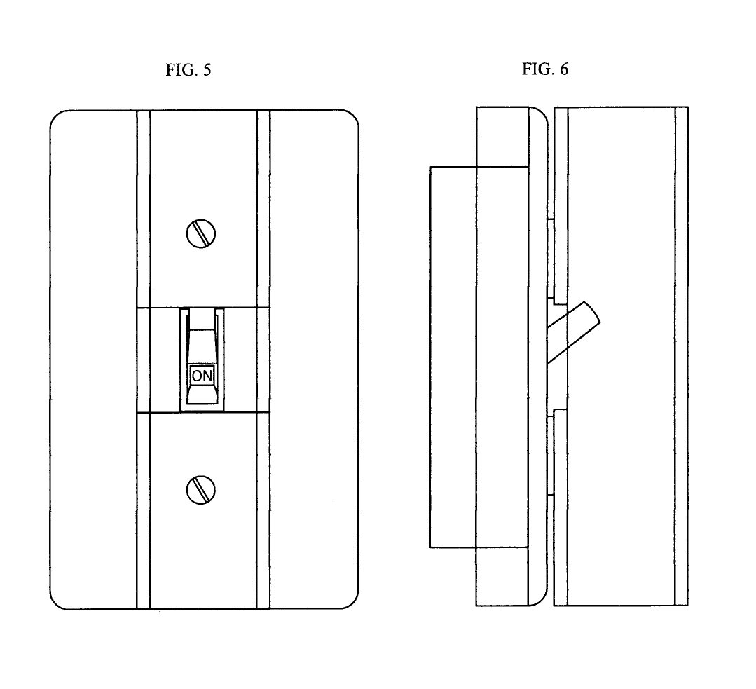

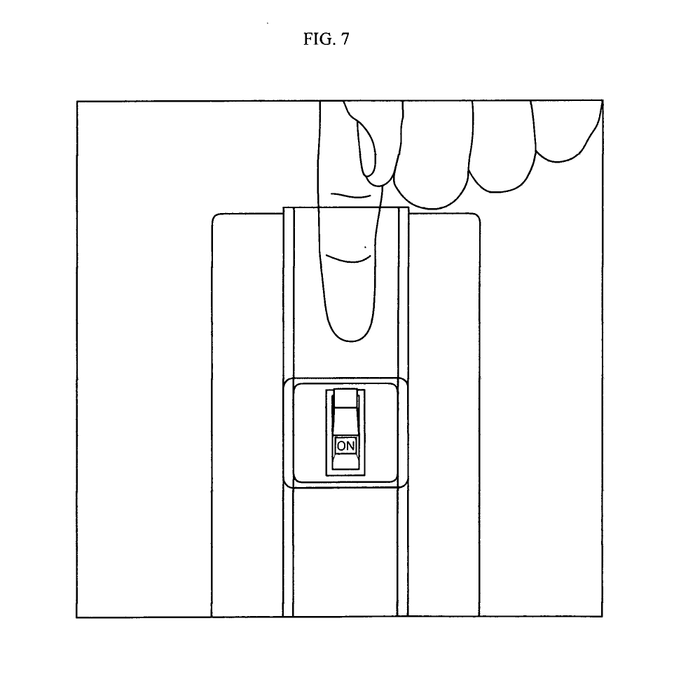

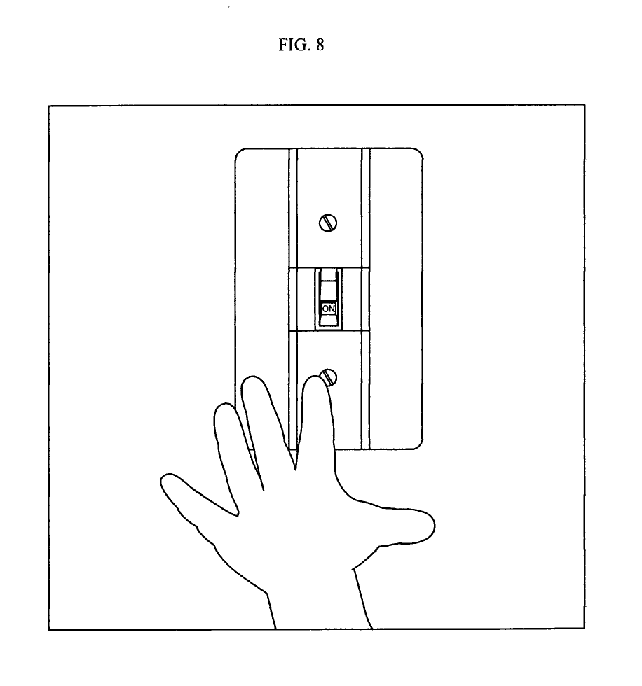

### DETAILED DESCRIPTION OF THE INVENTION

The childproof light switch guard is machined from 1.00 inch inside diameter, 1.25 inch outside diameter, 0.125 inch wall thickness, square, clear acrylic tube. The tube stock is cut to a length of 4.75 inches and a 1.00 inch square hole is milled out of the side of the cut tube to accommodate the light switch. Two 0.75 inch×1.00 inch pieces of clear double sided mounting tape are affixed to the switch guard above and below the square hole in the cut tube and are used for mounting the childproof light switch guard to the face plate of the light switch.

### DETAILED DESCRIPTION OF THE INVENTION

The light switch affected by the mounting of the childproof light switch guard can be accessed by an adult inserting an index finger down through the top hole or up through the bottom hole of the childproof light switch guard to push the light switch lever off or on respectively.

### DETAILED DESCRIPTION OF THE INVENTION

A small child's fingers are of insufficient length to reach the light switch lever and their whole hand will not fit into the upper and lower ends of the childproof light switch guard, thus restricting operation of the affected light switch.

1. A protective guard for use with a wall mounted light switch so as to render the light switch inoperable to small children.
The light switch affected by the childproof light switch guard remains fully functional to adults.
The childproof light switch guard works without any moving parts.
The childproof light switch guard leaves the affected light switch fully functional to adults without having to remove and reposition.
